(19) United States
(12) Patent Application Publication
(10) Pub. No.: US 2006/0179635 A1
(43) Pub. Date: Aug. 17, 2006

(54) Weir valve purge plate

(76) Inventor: Joseph Gross, Medina, NY (US)

Correspondence Address: CALFEE HALTER & GRISWOLD, LLP, 800 SUPERIOR AVENUE, SUITE 1400, CLEVELAND, OH, 44114, US

(21) Appl. No.: 11/057,992

(22) Filed: Feb. 15, 2005

(51) Int. Cl. B23P 25/00

(52) U.S. Cl. 29/458

(57) ABSTRACT

The invention is generally directed towards apparatuses and methods that provide for improved effectiveness in purging oxygen at a surface of a weir valve, as that surface is welded to another component. In one embodiment, the amount of oxygen at a weir valve weld surface can be lessened by more directly channeling inert gas into the portion of the internal flow path leading to the weld surface. In another embodiment, the amount of oxygen at a weir valve weld surface can be lessened by reducing the turbulence of inert gases flowing through the weir valve and over the welding surfaces.

### BACKGROUND

A weir valve is generally a component of a fluid flow system used to control flow of fluid through the system. A weir valve controls the flow of fluid, either allowing flow or stopping flow, by selectively engaging a diaphragm to a weir. A weir is a raised area in a valve flow path, normally located proximate to a valve cavity, that decreases the cross-sectional area of the path in a specific location. A diaphragm is typically a flexible member positioned over the valve cavity and proximate to the flow path that can be moved or deflected by an actuator or compressor. In a typical weir valve the diaphragm is deflected or moved into contact with the weir in order to close the cross-section area of the flow path that is left open by the weir. The contact between the weir and the diaphragm seals the flow path and stops fluid flow through the valve. To allow flow through the valve, the diaphragm is moved or deflected out of contact with the weir creating an opening in the flow path.

Weir valves are often manufactured from metals and can be incorporated into fluid flow systems through welding. Weir valves typically have end connections extending from the valve flow path that are dimensioned to interface with other flow system components, such as inlet and outlet pipes, tubes or other such channels. Valve end connectors are often welded to matching end connections on such other flow system components.

During the welding of metal components, it is customary to attempt to lessen or eliminate the presence of oxygen at or near the surfaces being welded. This process is often referred to as purging. Limiting or eliminating oxygen at these surfaces during welding can limit or eliminate oxidation at the site of the weld. Oxidation in a weld joint is often indicated by discoloration in the weld bead. Oxidation can lead to weakening of the weld joint over time due to corrosion of oxidized areas of the weld. One method of lessening or eliminating the presence of oxygen is to pass inert gases across the surfaces to be joined during the welding process. When welding a valve to a fluid flow system, inert gas is often passed through the internal flow path of the valve to create an inert atmosphere, which can lessen or eliminate the presence of oxygen and can minimize potential effects of oxidation in the weld joint.

The geometry of a weir valve provides some challenges in creating an inert atmosphere in the internal flow path of the valve at or near surfaces being welded. The weir typically separates a flow path into inlet and outlet portions. An inlet portion normally leads to an inlet end connector and an outlet portion will normally leads to an outlet end connector. As inert gas is passed through the internal flow path, typically entering the flow path through the valve cavity, it can be difficult to direct the inert gas into the specific portion of the flow path that leads to the surface being welded. In addition, the position of the weir and the restriction in cross-sectional area of the flow path at the weir can cause turbulence in the flow of inert gases delivered through the internal flow path. Each of these challenges can decrease the effectiveness of creating an inert atmosphere in the flow path and could lessen the ability to purge the weld area of oxygen.

Some welds that join weir valves to fluid flow system components have shown discoloration at the weld bead. If inert gases can be delivered to the weld area in a more direct or consistent manner to enhance the creation of an inert atmosphere, oxidation at the weld joint of a weir valve can be lessened or elimination and the resulting weld could be of higher quality and durability.

### SUMMARY OF THE INVENTION

The invention is generally directed towards apparatuses and methods that provide for improved effectiveness in purging oxygen at a surface of a weir valve, as that surface is welded to another component. In one embodiment, the amount of oxygen at a weir valve weld surface can be lessened by more directly channeling inert gas into the portion of the internal flow path leading to the weld surface.

In another embodiment, the amount of oxygen at a weir valve weld surface can be lessened by reducing the turbulence of inert gases flowing through the weir valve and over the welding surfaces.

Another embodiment of the invention is an adapter for routing a processing fluid through a weir valve flow port during welding of a member to a weir valve. The adapter comprises a weir valve cover and a processing fluid port for directing the processing fluid to the weir valve flow port.

### BRIEF DESCRIPTION DRAWINGS

FIG. 1 is a perspective view of a weir valve purge plate assembly;

FIG. 2 is an exploded view of a weir valve purge plate assembly;

FIG. 3A is a front view of a weir valve purge plate assembly;

FIG. 3B is a cross-sectional view of a weir valve purge plate assembly defined by cutting plane line A-A in FIG. 3A; and

FIG. 4 is a perspective view of a two stem weir valve purge plate assembly.

### DETAILED DESCRIPTION OF THE INVENTION

While the described embodiments herein are presented in the context of routing inert gases through a weir valve flow port during the welding of flow system components to a weir valve, those skilled in the art will readily appreciate that the present invention may be used in cooperation with many different valve and flow system configurations and with any system in which components are welded to a valve, including but not limited in any manner to: throttling valves; diverter valves; and valves welded into multiple inlet or multiple outlet flow systems. These examples are intended to illustrate the broad application of the invention for apparatuses and methods for providing processing fluids to valve flow ports in a more direct or consistent manner. The specific design and operation of weir valve purge plate assemblies and methods of using such provide no limitation on the present invention except as otherwise expressly noted herein.

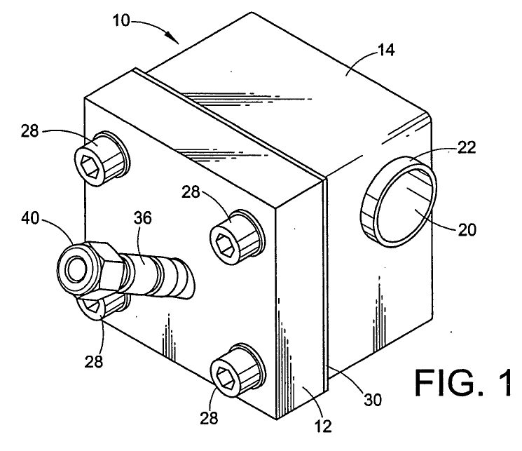

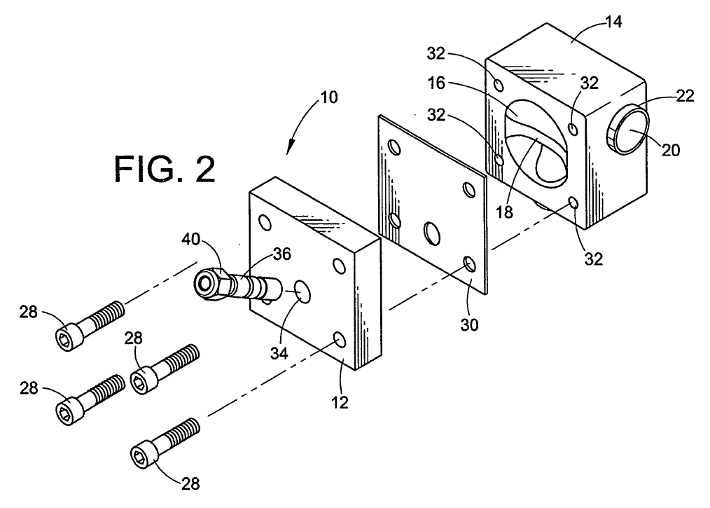

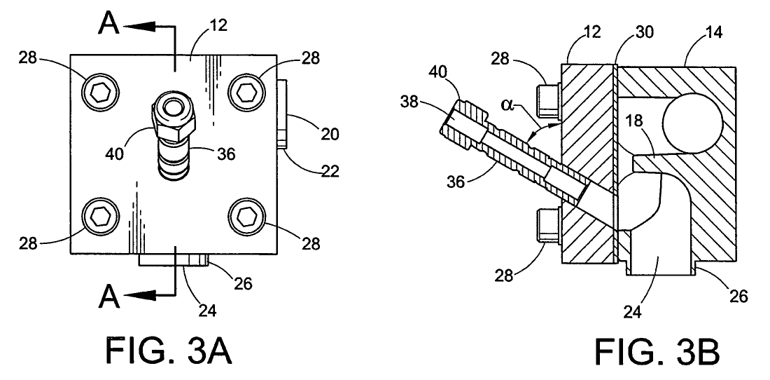

One embodiment of the invention is illustrated in FIGS. 1, 2, 3A, and 3B. FIG. 1 illustrates a perspective view of a weir valve cover 12 assembled to a weir valve 14 to create a weir valve purge plate assembly 10. FIG. 2 illustrates an exploded view of the assembly 10. FIG. 3A illustrates a front view of the assembly 10 and FIG. 3B illustrates a cross-sectional view of the assembly 10 defined by a cutting plane line A-A in FIG. 3A.

As shown in FIG. 2, the weir valve 14 includes a valve cavity 16, a weir 18, an inlet flow port 20, an inlet flow port end connector 22, an outlet flow port 24, and an outlet flow port end connector 26 (outlet flow port 24 and outlet flow port end connector 26 are shown in FIGS. 3A and 3B). Terms inlet and outlet as used herein are for convenience as flow can be reversed in some applications through the weir valve 14. Flow ports 20, 24 and end connectors 22, 26 can operate to allow fluid to enter the valve (inlet) or to allow fluid to exit the valve (outlet).

The inlet and outlet flow ports 20, 24 are located proximate to exterior surfaces of the weir valve 14. A flow path, internal to the weir valve 14, connects the inlet and outlet flow ports 20, 24. A weir 18 separates the flow path into two portions, a first portion leading to the inlet flow port 20 and a second portion leading to the outlet flow port 24. The valve cavity 16 is an opening on an exterior surface of the weir valve 14, located proximate to the weir 18. The valve cavity 16 normally accommodates a diaphragm (not shown) that can be moved or deflected into and out of contact with the weir 18. This movement or deflection of the diaphragm controls the opening and closing of the flow path at the location of the weir 18. When the diaphragm is in contact with the weir 18 the flow path is closed and when the diaphragm is removed from contact with the weir 18 the flow path is at least partially open.

The inlet and outlet flow port end connectors 22, 26 extend from the inlet and outlet flow ports 20, 24 respectively, and away from the weir valve 14. The end connectors 22, 26 can be designed and dimensioned to allow for flow system members or components to be attached to the weir valve 14 via the end connectors 22, 26. Examples of such members or components are: inlet or outlet channels, pipes, or tubes; flow splitters; and flow combiners. The attachment of flow system members or components to inlet and outlet flow port end connectors 22, 26 typically place these members or components in fluid communication with the weir valve 14, specifically the weir valve flow path. One common method of attachment is welding metal flow system members or components to inlet and outlet flow port end connectors 22, 26.

The weir valve cover 12 is attached to the weir valve 14 at the exterior surface where the valve cavity 16 is located. The purpose of attaching the weir valve cover 12 at this location is to allow for control of fluid flow through the weir valve flow path during the process of welding a flow system member or component to an inlet or outlet flow port end connector 22, 26. The weir valve cover 12 can be attached in a manner that seals the valve cavity 16 so that processing fluid flowing through the weir valve flow path is less likely to exit the weir valve 14 at the valve cavity 16 during a welding process. In the exemplary illustration shown in FIG. 1 the weir valve cover 12 is a flat plate attached to the weir valve 14 by four bolts 28; however, the method of attachment may be through any type of fastener or other method that will secure the weir valve cover 12 to the weir valve 14. Optionally, a gasket 30 can be placed between the weir valve cover 12 and the weir valve 14. The placement of the gasket 30 can enhance the seal between the weir valve cover 12 and the weir valve 14 to further control fluid flow though the weir valve flow path.

A weir valve 14 normally accommodates the attachment of a bonnet assembly over the valve cavity 16. A bonnet assembly normally includes a diaphragm and an actuator. The actuator can selectively move the diaphragm into the valve cavity 16 and into contact with the weir 18, which closes the weir valve flow path. The bonnet assembly may be attached to the weir valve 14 by bolts or other fasteners. In the exemplary illustration shown in FIG. 2, the weir valve 14 includes predrilled or tapped holes 32 to accept bolts 28. This embodiment takes advantage of the fastening system of the bonnet assembly by designing the weir valve cover 12 to fasten to the weir valve 14 in the same manner as does the bonnet assembly. This allows for a more convenient and secure attachment method without need to modify the weir valve 14.

The weir valve cover 12 includes a processing fluid port 34. In the exemplary illustration as shown in FIG. 2 the processing fluid port 34 is defined by an aperture passing through the weir valve cover 12. When the weir valve cover 12 is attached to the weir valve 14, fluid flow in and out of the valve cavity 16 can be controlled through the processing fluid port 34. A stem or lumen 36 extends from the processing fluid port 34 and away from the weir valve cover 12. As shown in FIG. 3B, the stem 36 can include a channel or chamber 38 running along the length of the stem body through which fluid can flow. The stem 36 can include a stem fitting or coupling 40 at one end to allow for the connection of a tube, hose, or other devise that can supply fluid into the stem 36 and subsequently into the weir valve flow path. The stem fitting can be a quick disconnect coupling, a threaded coupling, or any other type that would create a more secure attachment of a tube or hose to the stem 36.

In the exemplary illustration shown in FIG. 1, the stem 36 is shown as located below the midpoint of the weir valve cover 12 and generally angled downward toward the bottom of the weir valve cover 12. When the stem 36 is located in this position, a processing fluid passed through the stem 36 and into the weir valve 14 is encouraged or directed to flow into the portion of the flow path below the weir 18, which leads to the outlet flow port 24. The processing fluid can then flow through the flow path and exit the weir valve 14 through the outlet flow port 24, passing over potential welding surfaces. The weir valve cover 12 can be rotated 180 degrees so that the stem 36 is located above the midpoint of the weir valve cover 12 and the stem 36 is generally angled upward toward the top of the weir valve cover 12. In this position, a fluid passed through the stem 36 can be directed or encouraged to flow into the portion of the flow path above the weir 18, which leads to the inlet flow port 20. The processing fluid can then flow through the flow path and exit the weir valve 14 through the inlet flow port 20, passing over potential welding surfaces.

In the embodiment illustrated in FIG. 1, the secured attachment of the weir valve cover 12 to the weir valve 14, the placement location of the processing fluid port 34 in the cover 12, and the angle of the stem 36 can each enhance the ability to provide a processing fluid, such as an inert gas, to the inlet and outlet flow port end connectors 22, 26 during a welding process in a more direct or consistent manner.

The selectable alignment of the weir valve cover 12 allows the operator to select towards which flow port processing fluid will be directed. By allowing the cover 12 to be secured to the weir valve 14 so that the location of the processing fluid port 34 is either above or below the midpoint of the cover 12, the operator can selectively direct processing fluid towards either the inlet or outlet end connectors 22, 26 as that end connector 22, 26 is welded to another member or component. This ability to place the processing port 34 above or below the weir allows for a more direct deliver of processing fluid to a chosen end connector and can enhance an inert environment or atmosphere at an end connector during welding.

The secured attachment of the weir valve cover 12 to the weir valve 14 can create a seal that prevents fluid from flowing out of the valve cavity 16. The inclusion of a gasket 30 between the cover 12 and the weir valve 14 can further enhance the seal. If the seal prevents fluid from flowing out of the valve cavity 16, fluid directed into the cavity 16 will experience smoother and more laminar flow from the valve cavity 16 to the inlet or outlet ports 20, 24.

The placement location of the processing fluid port 34 in the weir valve cover 12 can also effect the fluid flow by controlling where fluid is introduced into the valve cavity 16. By placing the processing fluid port 34 off center and selectively above or below the weir 18, fluid can be introduced into the valve cavity 16 in a manner that minimized direct contact with the weir 18. The fluid can be introduced more directly into a portion of the flow path leading to either the inlet or outlet flow ports 20, 24. Limiting direct contact between fluid and the weir 18 can lessen turbulence in the fluid flow because the fluid will not have to be redirected into a portion of the flow path by the weir 18. A direct entrance of fluid into the flow path can promote more laminar fluid flow.

The angle α of the stem 36, with respect to the weir valve cover 12, can further control where the fluid is introduced into the valve cavity 16. In the exemplary illustration, best seen in FIG. 3B, the stem is angled in a manner to lessen contact between fluid entering the valve cavity 16 and the weir 18. In addition to the processing fluid port 34 being located below the weir 18, the angle a of the stem 36 further encourages the fluid to enter the valve cavity 16 below the weir 18 and can reduce contact between the fluid and the weir 18. Again the limiting of direct contact between fluid and the weir 18 will promote laminar flow and lessen turbulence in the flow of the fluid.

In the embodiment illustrated in FIGS. 1 through 3B, an inert gas, such as argon or nitrogen, can be directed through the stem 36 and into the weir valve 14, with the inert gas proceeding through the portion of the flow path leading to the outlet flow port 24. The configuration of the weir valve purge plate assembly 10 allows for a more direct introduction of an inert gas into the desired portion of the valve flow path and reduced turbulence in the flow of the gas, which allows for a more efficient and effective delivery of the inert gas to the outlet flow port 24. The efficient delivery enhances the inert environment or atmosphere at the outlet flow port end connector 26 by more effectively purging oxygen throughout the flow path. The limiting or elimination of oxygen at the outlet flow port end connector 26 during a welding process can lead to higher quality welds of tubes, channels, or other flow system members or components that are attached to the outlet flow port end connector 26. If the weir valve cover 12 is rotated 180 degrees so that inert gas is directed towards the inlet flow port 20, the atmosphere near the inlet flow port end connector 22 will be similarly purged of oxygen, leading to higher quality welds as tubes, channels, or other flow system members or components are welded to the inlet flow port end connector 22.

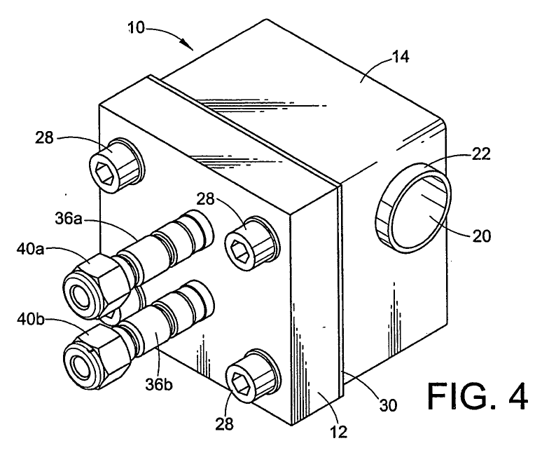

In another embodiment of the weir valve purge plate assembly, illustrated in FIG. 4, the weir valve cover 12 includes two processing fluid ports. In addition, there are two stems 36a, 36b extending from those processing fluid ports and away from the cover 12. This embodiment eliminates the need to rotate the cover 12 in order to selectively direct processing fluid to either the inlet or outlet ports 20, 24. One processing fluid port and an upper processing fluid stem 36a are located above the midpoint of the cover to coincide with the portion of the flow path leading to the inlet flow port 20 and one processing fluid port and a lower stem 36b are located below the midpoint of the cover 12 and coincide with the portion of the flow path leading to the outlet flow port 24. As one stem and processing flow port are in use, the other stem can be sealed or capped to restrict fluid from exiting the weir valve though that stem channel. For example, when the inlet flow port end connector 22 is welded to a component, an inert gas can be directed through the upper stem 36a and the lower stem 36b can be sealed or capped. The stem channel can be sealed or capped with a rubber stopper or any other method that is capable of sealing the channel of the stem. The illustrated embodiment in FIG. 4 shows the stems extending from the weir valve cover 12 at approximately a 90 degree angle, with respect to the cover 12. It should be understood that the stems may be angled as illustrated in FIGS. 1 though 3B.

The examples described herein can be used in a variety of methods. Including directing a processing fluid into the inlet flow port 20 and through the internal flow path as the outlet port end connector 26 is welded to a component. This can be accomplished by sealing or capping the stem or stems 36 extending from the weir valve cover 12 to restrict processing fluid from exiting the weir valve 14 through the stem or stems 36. The seal created by securing the cover 12 to the weir valve 14 and the sealing of the stem or stems 36 encourages the processing fluid directed into the inlet flow port 20 to proceed towards the outlet flow port 24 and pass over the outlet flow port end connector 26 as the end connector 26 is welded to another component. The above described process is equally applicable to directing a processing fluid into the outlet flow port 24 and through the internal flow path as the inlet port end connector 22 is welded to a component. It should also be understood that a weir valve cover 12 that does not include any processing fluid ports or stems would produce similar results to the above described sealing or capping of stems.

While various aspects of the invention are described and illustrated herein as embodied in combination in the exemplary embodiments, these various aspects may be realized in many alternative embodiments, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, and so on may be described herein, such descriptions are not intended to be a complete or exhaustive list of available alternative embodiments, whether presently known or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however, such values and ranges are not to be construed in a limiting sense and are intended to be critical values or ranges only if so expressly stated.

Having described the invention, it is now claimed:

1. An adapter for routing a processing fluid through a weir valve flow port during welding of a member to a weir valve, comprising:
a. a weir valve cover; and
b. a processing fluid port for directing the processing fluid to the weir valve flow port.

2. The adapter of claim 1, wherein the direction the processing fluid is routed can selectively be moved from a first side of a weir to a second side of the weir.

3. The adapter of claim 1, wherein the processing fluid port is defined by an aperture passing through the weir valve cover.

4. The adapter of claim 3, wherein a stem extends from the processing fluid port and further wherein the stem includes a channel through which a processing fluid can flow.

5. A system for routing a processing fluid through a weir valve flow port during welding of a member to a weir valve, comprising:
a. a weir valve, the weir valve comprising:
i. a valve cavity;
ii. a weir;
iii. a first weir valve flow port;
iv. a second weir valve flow port; and
v. a flow path connecting the first weir valve flow port and the second weir valve flow port;
b. a weir valve cover secured to the weir valve; and
c. a processing fluid port.

6. The system of claim 5, wherein the direction the processing fluid is routed can selectively be moved from a first side of the weir to a second side of the weir.

7. The system of claim 5, wherein the processing fluid port is defined by an aperture passing through the weir valve port cover.

8. The system of claim 7, wherein a stem extends from the processing fluid port, further wherein the stem includes a channel through which processing fluid can flow.

9. The system of claim 5, further comprising a gasket seated between the weir valve and the weir valve cover.

10. A method for routing a processing fluid through a weir valve flow port during welding of a member to a weir valve, comprising:
a. placing a cover over a valve cavity;
b. routing processing fluid to a weir valve flow port through a processing port in the cover;
c. placing the member in communication with the weir valve proximate to the weir valve flow port; and
d. welding the member to the weir valve as processing fluid passes through the weir valve flow port.

11. A method for routing a processing fluid through a weir valve flow port during welding of a member to a weir valve, comprising:
a. placing a cover over a valve cavity to seal the weir valve cavity;
b. routing processing fluid to a first weir valve flow port by introducing the processing fluid through a second weir valve flow port;
c. placing the member in communication with the weir valve proximate to the first weir valve flow port; and
d. welding the member to the weir valve as processing fluid passes through the first weir valve flow port.
